(19) United States
(12) Patent Application Publication
(10) Pub. No.: US 2017/0110259 A1
(43) Pub. Date: Apr. 20, 2017

(54) Electrical Energy Storage

(71) Applicant: The Governors of the University of Alberta, Edmonton (CA)

(72) Inventors: David Mitlin, Hannawa Falls, NY (US); Jia Ding, Edmonton (CA); Zhi Li, Edmonton (CA)

(21) Appl. No.: 14/885,966

(22) Filed: Oct. 16, 2015

(51) Int. Cl. H01G 11/34; H01G 11/86; H01G 11/50; H01M 12/00; H01G 11/36

(52) U.S. Cl. CPC H01G 11/34; H01M 12/005; H01G 11/36; H01G 11/50; H01G 11/86

(57) ABSTRACT

An electrical energy storage device, which may be for example a sodium ion capacitor (NIC), lithium ion capacitor (LIC), hybrid ion capacitor, a sodium ion battery or lithium ion battery. Active materials in either or both the anode and the cathode may be derived entirely or primarily from a single precursor: legume or nut shells, for example peanut shells, which are a green and highly economical waste globally generated in million tons per year.

### TECHNICAL FIELD

Electrical energy storage systems.

### BACKGROUND

Electrical energy storage (EES) systems play a crucial role in consumer electronics, automotive, aerospace and stationary markets. Due to sodium's effectively inexhaustible and democratically distributed reserves, Na—ion based energy storage devices are a promising alternative to the well-developed Li—ion technologies. There are primarily two types of devices for energy storage; batteries and electrochemical capacitors. The former offers a high energy density while the later offers high power. For instance, commercial lithium ion batteries deliver a specific energy upwards of 200 Whkg-1, but with a maximum specific power being below 350 Wkg-1. By contrast most electrochemical capacitors possess specific power values as high as 10 kW kg-1, but with specific energies in the 5 Wh kg-1 range. Yet a key target for an advanced electrical energy storage device is to deliver both high energy and high power in a single system.

A hybrid ion capacitor is a relatively new device that is intermediate in energy and power between batteries and supercapacitors. Since there is the potential to span the energy-power divide between the two systems, hybrid devices are attracting increasing scientific attention. The hybrid ion capacitor couples a high capacity bulk intercalation based battery-style negative electrode (anode) and a high rate surface adsorption based capacitor-style positive electrode (cathode). When employing Na+ and counter ions such as ClO4- as charge carriers, the device is termed NIC, i.e. sodium ion capacitor.38,43,45

Overall, the NIC field is quite young, with more research into improved electrode materials being desirable. Previously, researchers have primarily focused on improving the power capability of the anode in order to catch up with the fast kinetics of the capacitive cathode. NIC devices have been recently fabricated using the following anode-cathode combinations: V2O5/CNT//AC and NaxH2-xTi3O7//AC, with AC meaning conventional activated carbon. This creates a necessity to include excess mass (i.e. volume), generally several times more than that of the anode, in order to achieve the charge balance between the two electrodes. The Na ion insertion processes into the bulk of the negative electrodes are known to be substantially more kinetically sluggish than those for Li, posing a secondary major challenge to achieving attractive Na ion—based hybrid devices.

An inexpensive carbon-based negative electrode with a Na redox potential near Na/Na+ may not only provide a cost advantage over the inherently more costly inorganic materials but may also maximize the device energy density. Ideally such electrode materials would also be truly green, being derived from organic waste products that otherwise possess no economic value. Peanuts for example are a globally cultivated legume food staple, with the peanut shells having only limited commercial end-use as filler in animal feed or as charcoal. Researchers have prepared activated carbons from peanut shells and explored their applications in environmental science (e.g. sorbents for organic and metal pollutants removal) and energy storage (e.g. supercapacitor, lithium ion battery). These “classical” activated carbons were prepared by direct pyrolysis followed by high temperature activation. In terms of the synthesis methodology and by the resultant structure and performance, such ACs are analogous to commercial products, which are micro-scale particulates with tortuous 3D pore networks.

### SUMMARY

In an embodiment, which may be formed as a hybrid ion capacitor, there is disclosed an electrical energy storage device having an anode and cathode, at least one of the anode and cathode comprising separated inner shells or outer shells of a legume or nut that have been treated to obtain treated inner shells or outer shells with a macroscopically open structure composed of graphene or of carbon nanosheets. In various embodiments, there may be included: the separated inner shells or outer shells are inner shells primarily composed of lignin; the treated inner or outer shells comprise the inner shells that have been treated to form a structure composed of inter-dilated graphene layers for intercalating ions; the treated inner shells comprise the anode; the separated inner shells or outer shells are outer shells comprising multi-phase tissue including a cellulosic fibril network; the treated inner shells or outer shells comprise the outer shells that have been treated to form a structure composed of interconnected carbon nanosheets that provide adsorption sites for ions; the treated outer shells comprise the cathode; the treated inner shells or outer shells are thermally treated outer shells that form the cathode and have a structure created by pyrolysis in the presence of water; the inner shells or outer shells are inner shells or outer shells of peanuts.

In an embodiment, there is disclosed an electrode suitable for forming an anode of an energy storage device, the electrode comprising inner shells of a legume or nut formed primarily of lignin that have been thermally treated, the thermally treated inner shells being formed of pseudo-graphitic arrays of carbon, carbon of the thermally treated inner shells being activated to form inter-dilated graphene layers for intercalating ions. The inner shells may be inner shells of peanuts.

In an embodiment, there is disclosed an electrode suitable for forming a cathode of an energy storage device, the electrode comprising outer shells of a legume or nut that have been treated, the treated outer shells being formed of interconnected carbon nanosheets, the outer shells including a cellulosic fibril network, and the treated outer shells being formed of interconnected carbon nanosheets that provide adsorption sites for ions. The outer shells may be outer shells of peanuts.

In an embodiment, there is disclosed a method, and the material produced by the method in which the method comprises separating shells of a legume or nut into inner shells having a macroscopic sheet-like structure and outer shells, and treating the inner shells or the outer shells to obtain a macroscopically open structure composed of graphene or of carbon nanosheets. In various embodiments, there may be included: treating the inner shells or the outer shells comprises treating the inner shells by carbonizing the inner shells to produce carbonized inner shells; washing the carbonized inner shells with water: washing the carbonized inner shells with an aqueous solution of an acid; washing the carbonized inner shells with an aqueous solution of a base; carbonization is carried out at 400-1750° C.; activating the carbonized inner shells without destroying the macroscopic sheet-like architecture characteristic of untreated inner shells to produce activated carbonized inner shells; activating is carried out at 200-1750° C.; assembling anodes including activated carbonized inner shells for use in an electrical energy storage device; treating the inner shells or the outer shells comprises treating the outer shells until one or several phases comprising the outer shells are preferentially etched, producing preferentially etched outer shells, followed by washing and drying the preferentially etched outer shells; preferential etching is carried out in the presence of water and a pH-changing agent with or without heat; activating the preferentially etched outer shells, producing activated preferentially etched outer shells; activating the preferentially etched outer shells is carried out using an activation agent having a melting point and the activating is carried out above the melting point; separating the activated preferentially etched outer shells from the activation agent; separating the activated preferentially etched outer shells from the activation agent is carried out by washing the activated preferentially etched outer shells with water; drying the activated preferentially etched outer shells; and assembling cathodes including activated preferentially etched outer shells for use in an electrical energy storage device. There is also disclosed material produced by any of the disclosed methods.

### BRIEF DESCRIPTION OF THE FIGURES

Embodiments will now be described with reference to the figures, in which like reference characters denote like elements, by way of example, and in which:

FIG. 1 is shows exemplary anodes and cathodes and the main process steps of forming the anode and cathode;

FIG. 2 shows an exemplary energy storage device;

FIG. 3A shows a TEM micrograph of PSNC-3-800 highlighting the morphology of the carbon nanosheets.

FIG. 3B shows a low magnification SEM micrograph highlighting the morphology of PSOC-A with an insert highlighting the thickness of the carbon sheet.

FIG. 4 shows cyclic voltammograms (CVs) of PSNC-3-800.

FIG. 5 shows CVs of PSNC-3-850.

FIG. 6 shows CVs) of PSNC-2-800.

FIG. 7 shows CVs) of commercial activated carbon (CAC).

FIG. 8 shows galvanostatic discharge/charge profiles of PSNC-3-800, at current densities from 0.8 to 25.6 Ag⁻¹.

FIG. 9 shows the specific capacitance of PSNC versus current density.

FIG. 10 shows the cycling stability of PSNC (tested at 3.2 Ag⁻¹ for 10,000 cycles).

FIGS. 11A-D show the half-cell performance of PSOC and PSOC-A when tested in a half-cell configuration versus Na metal. (FIG. 11A) CVs of PSOC-A, tested at 0.1 mVs⁻¹. (FIG. 11B) Galvanostatic discharge/charge profiles of PSOC-A, tested at 0.1Ag⁻¹. (FIG. 11C) (left) XRD spectra for PSOC discharged at 50 mAhg⁻¹ to 0.2, 0.1 and 0.001 V. (right) The mean interlayer spacing at several cut-off voltages. (FIG. 11D) Rate performance and CE of PSOC and PSOC-A.

FIGS. 12A-C show the electrochemical performance of the hybrid Na-ion capacitors (NICs). (FIG. 12A) Galvanostatic profiles of PSNC-3-800//PSOC-A. (FIG. 12B) Ragone plot of PSNC-3-800//PSOC-A at 0° C., 25° C. and 65° C. The calculated energy and power densities are based on the total mass (solid) or volume (hollow) of the active electrodes. (FIG. 12C) Ragone plot (active mass normalized) comparing a device based on PSNC//PSOC-A to CAC//PSOC-A and to symmetric PSNC//PSNC and CAC//CAC systems. The PSNC//PSNC and CAC//CAC store charge based on EDLC only.

FIG. 13 shows the galvanostatic discharge/charge profiles of PSNC-3-800//PSOC-A hybrid Na-ion capacitor at low current densities.

### DETAILED DESCRIPTION

In an embodiment, we tailor the synthesis process to take full advantage of the unique structure of the peanut shell or other shell and in a particular embodiment achieve two fundamentally different (anode vs. cathode) very high performance electrodes from the same precursor.

There is disclosed an electrical energy storage device, which may be for example a sodium ion capacitor (NIC), lithium ion capacitor (LIC), hybrid ion capacitor, a sodium ion battery or lithium ion battery. Active materials in either or both the anode and the cathode are in an embodiment derived entirely or primarily from a single precursor: legume or nut shells, for example peanut shells, which are a green and highly economical waste globally generated in million tons per year. An exemplary ion adsorption cathode based on Peanut Shell Nanosheet Carbon (PSNC) displays a hierarchically porous architecture of open interconnected sheets of structured carbon, a sheet-like morphology down to 15 nm in thickness, a surface area on par with graphene materials (up to 2396 m²g⁻¹) and high levels of oxygen doping (up to 13.51 wt %). Scanned from 1.5-4.2 V vs. Na/Na⁺ PSNC delivers a specific capacity of 161 mAhg⁻¹ at 0.1A g⁻¹ and 73 mAhg⁻¹ at 25.6 Ag⁻¹. In another example a low surface area Peanut Shell Ordered Carbon (PSOC) is employed as an ion intercalation anode also with open interconnected sheets of structured carbon. PSOC delivers a total capacity of 315 mAhg⁻¹ with a flat plateau of 181 mAhg⁻¹ occurring below 0.1 V (tested at 0.1 Ag⁻¹), and is stable at 10,000 cycles (tested at 3.2 Ag⁻¹). The assembled NIC (in this instance) operates within a wide temperature range (0-65° C.), yielding at room temperature (by active mass) 201, 76 and 50 Wh kg⁻¹ at 285, 8500 and 16500 W kg⁻¹, respectively. At 1.5-3.5 V, the hybrid device achieved 72% capacity retention after 10,000 cycles tested at 6.4 Ag⁻¹, and 88% after 100,000 cycles at 51.2 Ag⁻¹.

While the specific example for which results are provided in this disclosure is for a sodium ion capacitor with anode and cathode derived from a peanut shell precursor, the structure of the anode and cathode also have utility in lithium ion batteries, sodium ion batteries, lithium ion capacitors, hybrid ion capacitors and conventional Supercapacitors since the structure of the anode and cathode is suitable for use in these applications. Based on the disclosed results, shells of other legumes or nuts may be used, that are digestible by a hydrothermal treatment, for example shells of peas, alfalfa, clover, lentils, lupins, mesquite, carob, soybeans, tamarind, broad beans and almonds, since the shells of these legumes and nuts are structurally similar to peanut shells. Likewise, the findings apply to any variety of the specified legumes or nuts, particularly where the outer shell is primarily lignin and the inner shell includes a cellulosic fibril network. Variations in oxygen or other content of the shells between kinds of legumes and nuts is expected to be of minimal impact on the structure of the carbon nanosheets produced from the legume and nut shells.

Shell structures produced by the disclosed methods come in two forms: One is a dense low surface area highly ordered pseudographitic (but not graphite) material that primarily stores charge by intercalation of ions between dilated graphene layers. It is like graphite, but with the intergraphene layers expanded by ˜20% allowing from greater insertion of a range of ions such as Li+, Na+, K+, Mg2+, Al3+.

The second form of shell carbon is a high surface area graphene-like carbon nanosheet, which stores ions (Li+, Na+, K+, Mg2+, Al3) by reversible adsorption at graphene defects such as Stone-Wales and divacancy. It also stores ions, i.e. charge, by metal underpotential deposition, aka nanoplating aka nanopore filling, which is something that does not occur in standard graphite. The carbon nanosheets are tuned by their nanometer-scale thickness to have very low solid-state diffusional distances, giving superior rate capability.

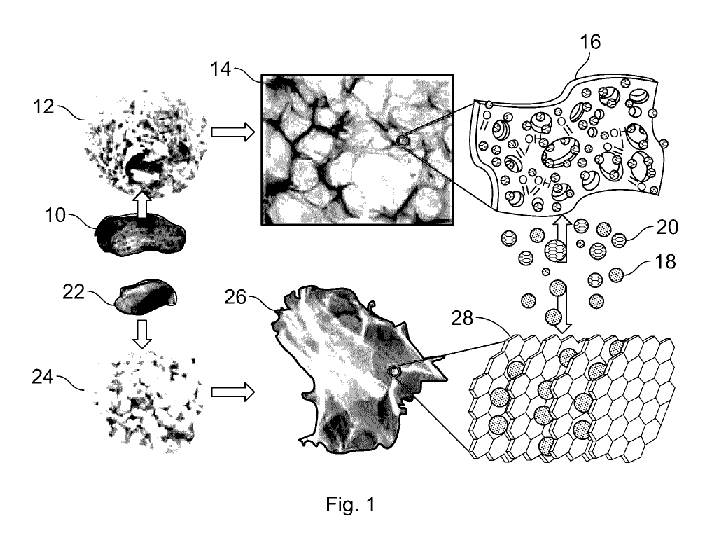

The overall process for an embodiment is shown in FIG. 1. A peanut outer shell 10 is separated from inner shell 22. The outer shell 10 is hydrothermally treated 12 with at least partial carbon activation, for example by KOH or NaOH treatment, to yield a thermally treated outer shell material 16 of carbon nanosheet (PSNC). The thermally treated outer shell material 16 may form a cathode 14 of an energy storage device for adsorbing ions 18, 20, for example sodium ions 18 and chlorate ions 20. Inner shell 22 is thermally treated by carbonization 24 with mild air activation to form a thermally treated inner shell material 28 of ordered or structured carbon nanosheets (PSOC) that may be used as the anode 26 of an energy storage device. The anode 26 may store energy by intercalation of ions, for example sodium ions.

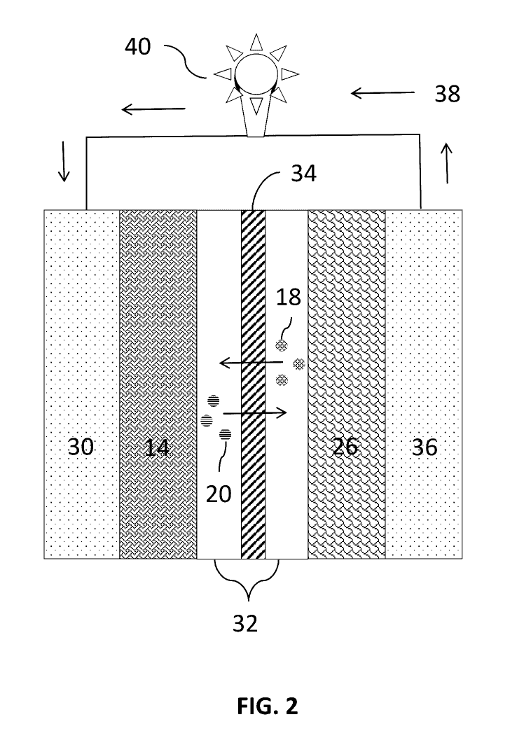

Referring to FIG. 2, an electrical storage device may comprise a current collector 30, cathode 14 prepared as shown in FIG. 1 and described herein, electrolyte 32, separator 34, anode 26, made as shown in FIG. 1 and as described herein, current collector 36 and circuit flow elements 38 including device 40. The electrolyte may be organic, ionic liquid, aqueous or a combination. Standard battery and supercapacitor electrolytes will work. Standard battery separators and current collectors will work. One or both of the electrodes 14, 26 may be a straight substitution into a conventional battery or supercapacitor device. Either of the structures 16, 28 may be employed as anode or as cathode, with the appropriate tuning of the device voltage and of the counterelectrode configuration, although in some instances superior performance is obtained when the materials are optimized for their respective roles. For instance one embodiment is substituting either the carbon nanosheet 16 or the dense pseudographite carbon 28 for the graphite anode in a conventional Li ion battery. This may give superior charge storage capacity and rate capability. A variety of ions may be used as the cations 18, e.g , Li+, Na+, K+, Mg2+, Al3+, combination, etc, and the anions 20.

Charge carrier ions, Li+, Na+, K+, Mg2+, Al3+, combination, their counter anions may also be present in the electrodes 14, 26 depending on the embodiment. Binder and carbon black (or other electrical conductivity phase) may also be present in the electrodes 14, 26 depending on the embodiment. Also a range of functional phases may be present in the electrodes 14, 26 such as Si, Sn, Sb, their oxides, S, Li2S, Na2S, MoS2, MnO, Pt, Pd, Au, Ir, Ni, Co, Ag depending on the embodiment. The carbon nanosheets in the electrodes 14, 26 may be also have surface functionalization with oxides, nitrides, Si, carbides, sulfides, Pt, Pd, Au, Ni, alloys, oxygen, nitrogen, sulfur, for example for use in Na ion batteries, Li ion batteries, supercapacitors, fuel cell electrocatalysts, other electrocatalysts and chemical catalysts.

Referring to FIG. 1, we begin with the material synthesis process employed for each of the electrodes. The peanut shell is firstly separated into two parts, 10 and 22. The inner portion 10 of the shell is used as the precursor for the negative electrode 14 (designated “anode”). The anodes are prepared by carbonization (for example 1200° C. in argon), followed by a mild low temperature (for example 300° C.) activation treatment in air. Unlike conventional high temperature activation, typically performed in excess of 600° C., this treatment was unique in introducing sufficient porosity but not destroying the macroscopic sheet-like architecture of the precursor. Because of their resultant structure, these materials are labelled Peanut Shell Ordered Carbon (PSOC) in the test results. Since not all specimens were activated, we added the ending “-A” i.e. PSOC-A to the ones that were. The outer rough shell is employed as the precursor for the positive electrodes (“cathode”). These carbons are prepared by hydrothermal treatment (described in experimental) followed by chemical activation (for example at 800-850° C. in argon). Because of their resultant structure, these carbons are labelled Peanut Shell Nanosheet Carbon (PSNC) in the test results. The specific nomenclature is PSNC-x-y, where x refers to the mass ratio between the KOH and the biochar obtained after the hydrothermal treatment, while y refers to the activation temperature. A high surface area Commercial Activated Carbon (NORIT A SUPRA, steam activated), labeled CAC, was also employed as baseline for cathode testing.

The decision to employ the inner shell as the anode and the outer shell as the cathode was based on our understanding of the differences in their plant structure, and how those may be transformed to the target final electrodes' microstructure. The peanut shell, and shells of other legumes and nuts, is primarily a combination of cellulose, hemicellulose and lignin. However its tissue is highly heterogeneous, with the inner versus the outer shell containing different relative fractions and distribution of each phase. Our sodium ion capacitor (NIC) device in one embodiment comprises an intercalation anode and an adsorption cathode, which for best results, requires carbons with fundamentally different degrees of graphene ordering, surface area/porosity, and surface functionality for each electrode.

We chose the inner shell for the anode because it is the most homogenous portion of the shell, being primarily composed of lignin. Lignin is a three-dimensional, highly cross-linked polyphenolic polymer without any ordered repeating units. This lignin-rich tissue prevented large-scale formation of equilibrium graphite during high temperature pyrolysis but allowed for pseudographitic ordering of the defective graphene planes. Such ordering results in a structure composed of highly inter-dilated graphene layers (as compared to equilibrium graphite), which is thus able to easily intercalate the large Na ions. The NIC's battery-like ion intercalation anode does not need to possess a high surface area, as ion adsorption was not a significant charge storage mechanism. Therefore the inner shell's relatively homogeneity was not a major concern, as it did not require to be separated into nanosheets, etc. through preferential chemical etching.

Conversely the NICs capacitor-like adsorption cathode required a very high surface area and facile ion diffusion/access through the electrolyte. We were looking for a precursor that ideally could be transformed in to an electrochemically graphene-like analogue. From our previous work on processing plant-based materials we knew that the key to achieving such properties is to begin with a precursor that is highly heterogeneous but with nano-scale periodicity. We needed something where one or several of the phases could be preferentially etched while leaving behind intact sheets or other 2-D structures. The outer skin of the peanut shell was cellulose-rich but highly heterogeneous. It, and the outer skin of other legumes and nuts, consists of an interconnected cellulosic fibril network (crystalline cellulose), with the individual microfibrils being roughly 10-30 nm in diameter. These microfibrils are interlinked by a minority phase of much shorter branched polysaccharide tethers (hemicellulose) and polyphenolic polymers (lignin). Such multi-phase tissue, abundant in cellulose fibrils, is an ideal precursor to achieve interconnected carbon nanosheets through a hydrothermal+chemical activation process, which in parallel adds capacitance-enhancing surface functional groups.

Low-magnification scanning electron microscopy (SEM) micrographs show that PSNC-3-800 morphologically resembles a macroscopically open sponge, unlike CAC, which is a micron-scale 3D particulate. SEM micrographs of PSNC-3-850 and PSNC-2-800 demonstrate that both carbons possess an analogous morphology as PSNC-3-800, although with decreasing levels of macroscopic “openness” in the same order.

The morphology of PSNC is attributable to a synthesis strategy that is tailored to take the maximum advantage of the structure of the outer shell. Under the relatively aggressive conditions of a hydrothermal treatment, the minority non-crystalline components are hydrolyzed and dissolved. However the interconnected cellulosic fibril network is not fully dissolved. Rather, the hydrothermal process degrades the overall crystallinity and loosens the connections between the microfibrils. The hydrothermal process also partially carbonizes them, resulting in the preservation of a cellulose “scaffold” on the micron-scale, as observed in the SEM images (for example, as shown as element 14 in FIG. 1). During chemical activation the pores left over from the dissolution of non-crystalline components serve as channels for the capillarity-driven infiltration of liquid KOH, further loosening the microfibril networks to create the carbon nanosheets and punching secondary micro and meso porosity into the structures. In order to reinforce the discussion concerning the rationale for precursor selection, we employed the entire peanut shell as a single precursor, with the same synthesis procedures as PSNC-3-800. SEM micrograph confirmed that the resultant carbon specimen did not display macroscopically open sheet-like morphology.

During electrochemical testing the open architecture of PSNC will allow full access of the electrolyte to the active surfaces, minimizing high rate diffusional losses through the liquid. By contrast, commercial activated carbons including CAC are known to contain a tortuous pore network that penetrates microns deep into the particulates. Especially at high scan rates/current densities this will result in significant ion diffusional losses.

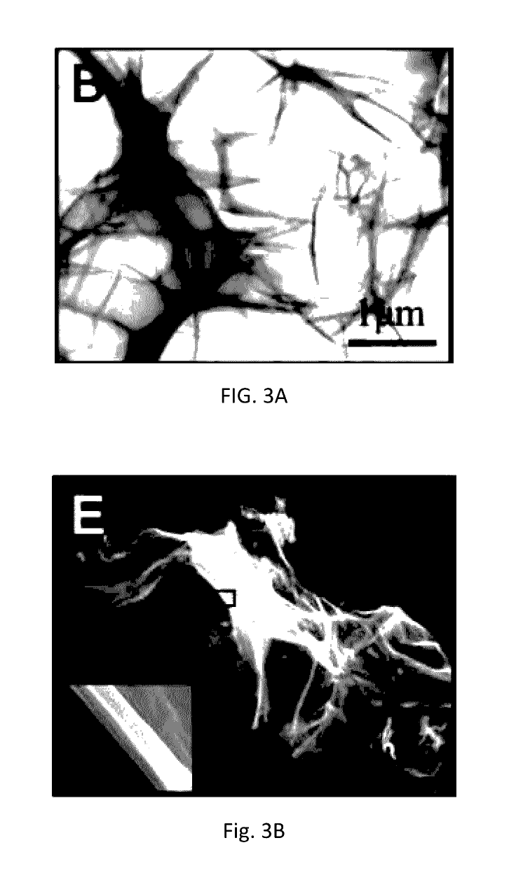

Transmission electron microscopy (TEM) can be used to demonstrate further that the structure of PSNC-3-800 consists of three-dimensional arrays of carbon nanosheets (FIG. 3A). High angle annual dark field (HAADF) scanning TEM (STEM) and low-loss electron energy loss spectroscopy (EELS) yield thickness profiles of the PSNC specimens. PSNC-3-800 has carbon nanosheet thickness in the range of 15-25 nm, which is thinner than that of PSNC-3-850 (40-60 nm). Due to the insufficient chemical etching, PSNC-2-800 has the largest carbon sheet thicknesses, being up to 140 nm. High resolution TEM (HRTEM) demonstrates the low degree of ordering in all three PSNC specimens.

PSOC-A and PSOC, which are synthesized from the inner peanut shell, can be shown by SEM to exhibit a macroscopically open structure (FIG. 3B), which is unaffected by activation. The typical sheet thickness is on the order of 300 nm. The specimen derived from the integral peanut shell mainly comprises solid μm-size irregular-shaped carbon particles lacking macroscopic openness. The tissue of the inner peanut shell possesses a much higher content of three-dimensional highly cross-linked lignin. During high temperature pyrolysis such a precursor will act as a “hard” carbon, preventing large-scale formation of equilibrium graphite at temperatures as high as 1400° C. However during carbonization the material will order locally, creating pseudo-graphitic arrays with dilated intergraphene spacing. HRTEM confirms that PSOC and PSOC-A primarily consist of partially ordered graphene domains, which may be described as “pseudographitic”, as for example element 26 in FIG. 1

X-ray diffraction (XRD) patterns of the PSOC and PSNC have been obtained. The patterns of PSOC show two broad diffraction peaks that are indexed as (002) and (100) of the pseudographitic domains. These peaks are barely discernable in PSNC, indicative of its much lower ordering. Moreover the PSOC patterns display the presence of a minor amount (estimated to be ˜1 wt %) of equilibrium graphite, which is indexed separately. The average graphene interlayer spacing can be calculated from the center position of (002) peaks. As Table 1 shows, the mean intergraphene layer spacing (d₀₀₂) for PSOC is significantly larger than that of graphite (0.3354 nm). We will demonstrate that this dilated intergraphene spacing allows for facile Na ion intercalation into the bulk of the PSOC-based negative electrode. To further understand the graphene plane arrangement in our materials, we employ an empirical parameter (R), defined as the ratio of height of the (002) Bragg peak to the surrounding background. (The height of the background is determined, approximately, by linearly fitting the background of the peak and taking the height of the fit at the peak's center.) It has been argued that the value of R could credibly characterize the concentration of the graphene sheets arranged as single layer, with a larger R indicating a lower percentage of single graphene sheets within a carbon. The R values for PSOC are an order of magnitude higher than they are for PSNC (20-23 vs. ˜2), agreeing with our interpretation of the HRTEM images. Activation of PSOC does increase R, for example from 20.1 to 23.7, presumably by preferentially volatilizing to CO₂ the less ordered portions of the material. The average dimensions of the ordered graphene domains (Lₐ, L_{c}) could be calculated by the well-known Scherrer equation, using the full width at half maximum values of (002) and (100) peaks, respectively. As shown in Table 1, the domain thickness is relatively invariant from sample to sample (including for CAC), ranging from 1.51-1.84 nm. However with domain width is twice as large for PSOC versus PSNC or CAC (˜8 nm vs. ˜4 nm).

The structure of the carbons was further investigated by Raman spectroscopy. All the specimens exhibit broad disorder-induced D-bands (≈1340 cm⁻¹) and in-plane vibration G-bands (≈1580 cm⁻¹). The values of the integral intensity of D- and G-bands could be obtained by fitting the spectra with I_{G}/I_{D} being employed to index the degree of graphitic ordering. As Table 1 shows, for PSOC the I_{G}/I_{D} values are 1.01-1.1, for PSNC they are 0.41-0.62, while for CAC the ratio is 0.26. PSOC also exhibited second order 2D and D+G peaks, which are also associated with their more ordered structure. PSNC displayed an electrical conductivity in the range of 181-227 S cm⁻¹, being a factor of five higher than that of CAC (43 S cm⁻¹). Although we were unable to press PSOC into sufficiently dense “pucks” as to perform satisfactory 4 point probe conductivity measurements, it is expected that these highly ordered—low surface area carbons will be similarly much more conductive than CAC.

TABLE 1
Carbon structure, electrical conductivity and textural properties of
Peanut Shell Nanosheet Carbon (PSNC) and Peanut Shell Ordered Carbon
(PSOC), with baseline commercial activated carbon CAC also shown.

| | | | | | | | Textural Properties | | | |
|---|---|---|---|---|---|---|---|---|---|---|
| | Carbon Structure | | | | | | | | micro- | meso- |
| | d₀₀₂ | | Lₐ | L_{c} | | s | S_{BET} | Vₜ | pores | pores |
| Sample | (Å) | R | (nm) | (nm) | I_{G}/I_{D}^{a} | (S cm⁻¹) | (m² g⁻¹)^{b} | (cm³g⁻¹)^{c} | % | % |
| NC-3-850 | 4.12 | 2.1 | 4.43 | 1.51 | 0.56 | 227 | 1998 | 1.21 | 70.2 | 29.8 |
| PSNC-3-800 | 4.13 | 1.9 | 3.75 | 1.71 | 0.41 | 181 | 2396 | 1.31 | 64.5 | 35.4 |
| PSNC-2-800 | 4.11 | 2.2 | 4.49 | 1.55 | 0.62 | 192 | 1376 | 0.91 | 77.5 | 22.5 |
| PSOC | 3.78 | 20.1 | 7.95 | 1.80 | 1.10 | — | 78 | 0.074 | 45 | 55 |
| PSOC-A | 3.79 | 23.7 | 8.04 | 1.84 | 1.01 | — | 476 | 0.31 | 77.8 | 22.2 |
| CAC | 3.72 | 3.8 | 4.20 | 1.84 | 0.26 | 43 | 2050 | 1.17 | 67.7 | 32.3 |

^{a}I_{D} and I_{G} are the integrated intensities of D- and G-band.
^{b}Surface area was calculated with Brunauer-Emmett-Teller (BET) method.
^{c}The total pore volume was determined at a relative pressure of 0.98.

The nitrogen adsorption-desorption isotherms of PSNC, PSOC, and CAC were measured, and pore size distributions were obtained by density functional theory (DFT). Table 1 provides the porosity characteristics of the peanut shell derived materials and of CAC. Type I/IV isotherms could be found for all the PSNC specimens, which all possess considerable porosity and high surface areas. The surface area and the pore volume fraction of micropores vs. of mesopores (and total pore volume) depend on the activation conditions. Overall both the highest surface area (2396 m² g⁻¹, being desirable for maximizing the total ion adsorption) and the highest fraction of mesopores (35.4%, being desirable for rapid electrolyte diffusion) were achieved in the PSNC-3-800. A higher activation temperature or a lower ratio of KOH to carbon resulted in a reduction of both attributes. CAC actually possesses an on par surface area (2050 m² g⁻¹) and mesopore content (32.3%). However due to its lower electrical conductivity and a “closed” particulate morphology CAC will be demonstrated to be a far inferior electrode at high charge rates.

X-ray photoelectron spectroscopy (XPS) and combustion elemental analysis were employed to investigate the surface and bulk chemical composition of PSNC and PSOC. Table 2 lists the surface composition of the carbons, the oxygen functionalities, and the bulk C, O, N and H results of the elemental analysis. Based on the XPS survey spectra, the content of impurities (Si, Cl) is 0.9 wt % in total. Other potential impurities that may be present in plant-based precursors (e.g. P, K, Mg, Ca) were below the detection limits of XPS analysis, being both volatilized during synthesis and further removed by the post-synthesis HCl wash.

TABLE 2
Surface chemistry of PSNC and PSOC, with baseline CAC also

| | Surface | | | | | | | | | |
|---|---|---|---|---|---|---|---|---|---|---|
| | Chemistry (XPS) | | | Functionality | | | Elemental analysis^{a} | | | |
| | C | N | O | (% of total O 1 s) | | | C | N | O | H |
| Sample | (wt %) | (wt %) | (wt %) | O-I | O-II | O-III | (wt %) | (wt %) | (wt %) | (wt %) |
| PSNC-3-850 | 89.45 | 0.85 | 9.70 | 44.15 | 51.87 | 3.98 | 90.44 | 0.93 | 7.41 | 0.21 |
| PSNC-3-800 | 85.91 | 0.58 | 13.51 | 53.94 | 41.83 | 4.23 | 86.51 | 0.65 | 12.21 | 0.13 |
| PSNC-2-800 | 87.31 | 0.96 | 11.73 | 44.58 | 43.04 | 12.38 | 88.31 | 0.94 | 9.97 | 0.33 |
| PSOC | 93.70 | 0.73 | 5.57 | 55.72 | 29.44 | 14.83 | 92.82 | 0.46 | 5.04 | 1.08 |
| PSOC-A | 92.94 | 0.97 | 6.09 | 39.41 | 55.28 | 5.31 | 91.85 | 0.74 | 5.71 | 1.10 |
| CAC | 95.35 | ~0 | 4.65 | 45.32 | 47.15 | 7.53 | 94.12 | 0.12 | 4.34 | 0.43 |

shown.

^{a} Weight percent of elements obtained from combustion analysis.

The unactivated biochar obtained after the hydrothermal process possessed a significant content of O (34.2wt %, results not shown). After chemical activation, a large portion of oxygen heteroatoms is preserved, with 11.7 wt %, 13.5 wt % and 9.7 wt % oxygen content for PSNC-2-800, PSNC-3-800 and PSNC-3-850 respectively. High-resolution O 1s and C 1s XPS spectra of PSNC-3-800 and of the other materials were obtained. The high resolution O 1s spectra could be deconvoluted using 3 peaks representing the 3 different types of oxygen functional groups: C═O quinone type groups (O-I, 531 eV), C—OH phenol/C—O—C ether groups (O-II, 532.4 eV), and COOH carboxylic groups (O-III, 535.4 eV). The surfaces in all the specimens are primarily covered by O-I and O-II functionalities, with O-III being a relative minority. For instance in PSNC-3-800 the relative weight percent is 53.9% for O-I, 41.8% for O-II and 4.2% for O-III. In PSOC and PSOC-A the amount of O was much lower, being 5.6 wt % and 6.1 wt %. In all PSNC and PSOC the N content was below 1 wt %. Baseline CAC contained 4.65 wt % O and negligible N. The N content in all carbons is sufficiently low that it is not expected to meaningfully contribute to the charge storage capacity.

Here we describe the electrochemical performance results for PSNC, which may be employed for example as the cathode in an exemplary hybrid NIC device. PSNC was tested in a half-cell configuration versus Na metal, in a voltage window previously employed for hybrid Na-based cathodes (1.5-4.2V). This range maximized the operating voltage window without decomposing the electrolyte, or intercalating ions into the bulk of the carbons to an appreciable extent. Upon positive polarization the PSNC electrode will reversibly adsorb ClO₄⁻ and reversibly release Na⁻. Capacitance is achieved both by EDLC of ClO₄⁻, and through a pseudocapacitive interaction of Na⁺ with surface defects and oxygen functionalities.

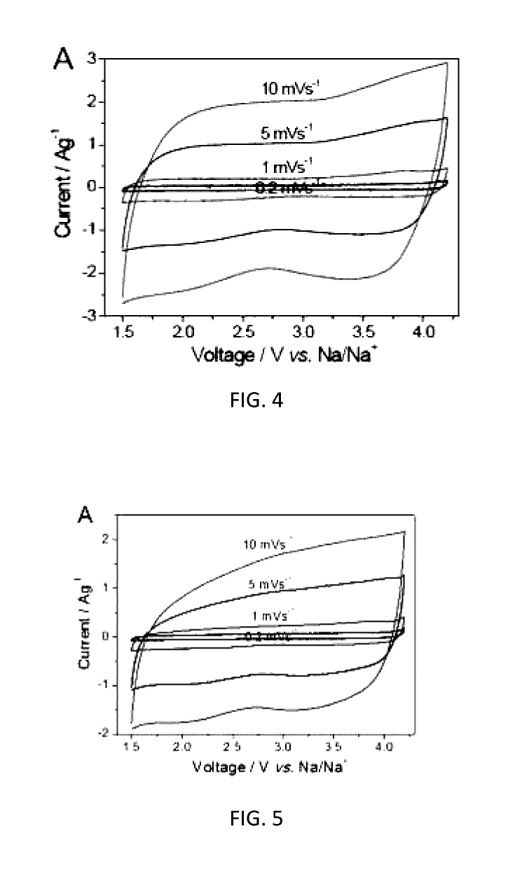

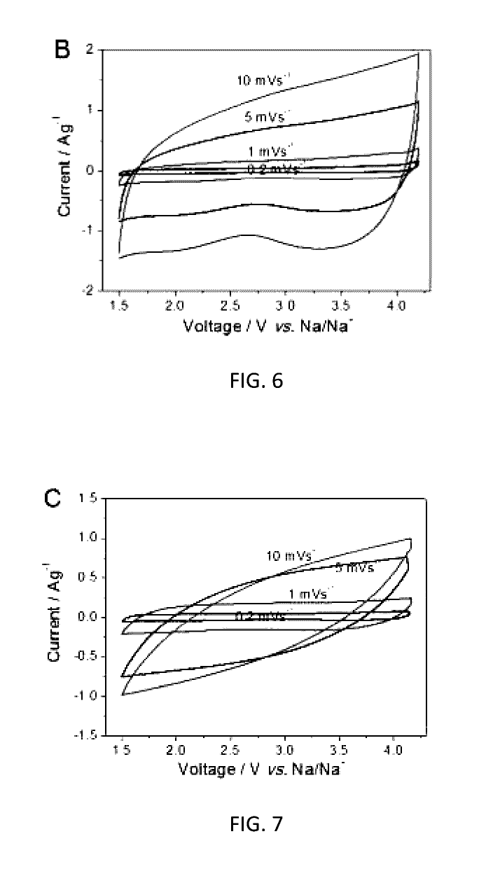

The cyclic voltammogram (CV) curves of PSNC-3-800 electrode display a box-like shape, indicative of typical EDLC behavior, overlaid with pseudocapacitive humps (FIG. 4). FIGS. 5-7 shows the same CV data for PSNC-3-850, PSNC-2-800 and CAC carbons. The level of IR loss—induced distortion in the CVs at higher scan rates for the materials goes effectively in the order of the “openness” of the structures: With increasing scan rate (0.2-10 mVs⁻¹) the PSNC-3-800 specimen displayed negligible shape distortion. PSNC-3-850 was the second least distorted, the PSNC-2-800 was the third least distorted. Of all the carbons, the high scan rate CVs of the particulate-like CAC were by far the most distorted.

The anodic and cathodic current dependence on the CV scan rate was measured at 2.75 V. At scan rates from 1 to 50 mV s⁻¹ the PSNC-3-800 electrode maintained linearity. For PSNC-3-850 and PSNC-2-800, the onset for deviation from linearity is 25 mV s⁻¹ and 15 mV s⁻¹, respectively. For CAC, the charge storage reaction became diffusion limited at very low rates, i.e. below 5 mV s⁻¹. A transition from a linear dependence of current to square root dependence is considered an indicator of the onset of diffusion-limited reactions, and supports the argument that the ion transfer kinetics for the open PSNC structures is much more facile as compared to CAC. Since the charge storage mechanisms for PSNC are surface adsorption based, one can argue that the carbons' open structure reduces the ion diffusional limitations in the electrolyte (rather than in the bulk). Differences in pore shapes may also play an important role. Pores in PSNC could provide smoother inner-pore transport channels for ions as compared to conventional activated carbons.

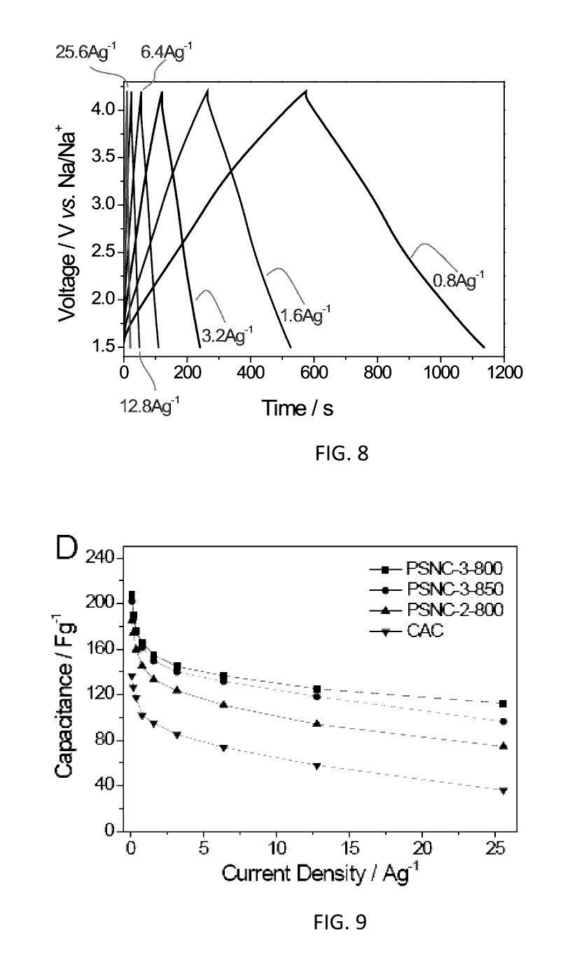

The galvanostatic charge/discharge profiles for the PSNC electrodes are symmetrical with low IR drops (FIG. 8). Conversely, the profiles for CAC are quite distorted at higher current densities. CAC's pore tortuosity and inferior electrical conductivity both contribute to the larger CV distortion at high rates and the higher IR drops.

CAC shows the greatest IR loss with increasing current density, up to approximately 1.3 V at 25.6 Ag⁻¹. The IR loss increases more slowly for PSNC-3-850 and PSNC-2-800, and most slowly for PSNC-3-800, reaching approximately 0.9 V and 0.4 V, respectively, at 25.6 Ag⁻¹.

The specific capacitance of the PSNC and the CAC electrodes was measured as a function of current density (FIG. 9). The optimized PSNC-3-800 delivered a capacitance of 213Fg⁻¹ at current density of 0.1Ag⁻¹, which gave surface normalized capacitance of 8.9 μFcm⁻² (based on BET surface area). The PSNC electrodes consistently outperformed the tested CAC through the entire current range of testing. However the performance difference is most stark at the very high currents, where electrolyte diffusional limitations are manifest: at 25.6 Ag⁻¹ PSNC-3-800 delivers 119 Fg⁻¹ while CAC delivers 36 F/g. Likewise, the cathode carbon derived from the integral peanut shell as the precursor delivers less than two-thirds of the capacitance of PSNC-3-800 at 25.6 Ag⁻¹. Its inferior capacitance further proves the essential function of the macroscopic openness and the sheet-like morphology of PSNC-3-800.

Overall the PSNC-3-800 electrode offers the best performance, which may be attributed to its optimum combination of O content, surface area and mesopore content, the later becoming critical at high scan rates. The most reactive oxygen functional groups should be the quinone type groups (C═O/O—C═O, O—I type) due to the unsaturated carbon-oxygen double bond. As covered earlier, all PSNC materials possess significant O—I content, with PSNC-3-800 being the richest both in terms of weight fraction (53.94%) and the total amount. It has been previously argued that between 1.5-4.2V vs. Na/Na⁺ there is substantial charge storage capacity associated with reversible Na⁺ binding to this moiety. This therefore is another reason for the optimum performance in PSNC-3-800 versus PSNC-3-850 or PSNC-2-800. While CAC contains an analogous fraction of O—I, its overall oxygen content is three times lower.

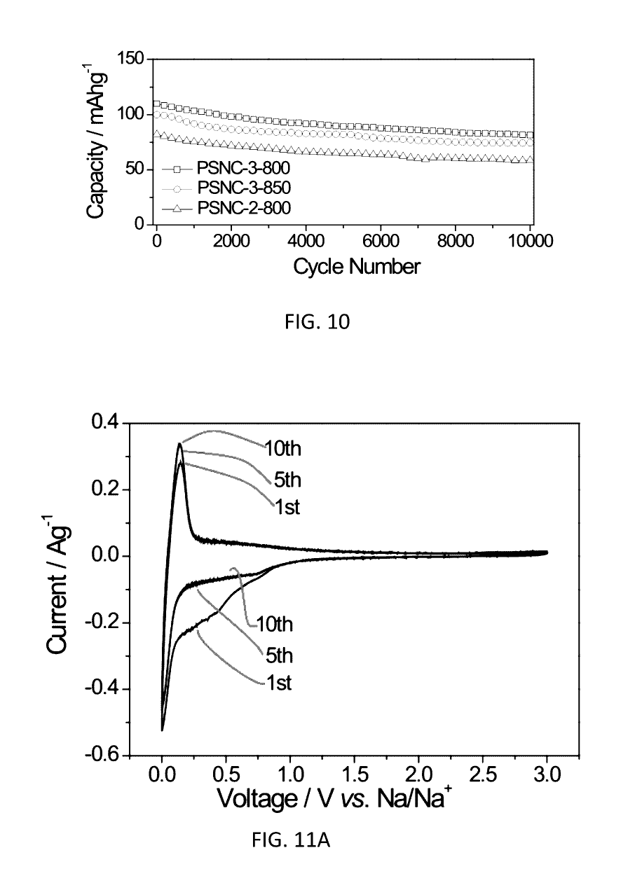

The cycling performance of PSNC was tested at 3.2 Ag⁻¹(FIG. 10). For a consistency with the PSOC data, the results are presented in terms of specific capacities (mAhg⁻¹) rather than capacitances. The capacitance C (F g⁻¹) is defined as C=i×t/V, where i is the active mass normalized current density and t is discharge time obtained from the galvanostatic discharge curve. The voltage window V is defined as V=Vₘₐₓ−Vₘᵢₙ, where Vₘₐₓ is the voltage at the beginning of discharge after the IR drop and Vₘᵢₙ is the voltage at the end of discharge. The specific capacity Q of a half-cell is Q=i×t. Thus a conversion of a measured capacitance to a measured capacity requires a straightforward multiplication of C by V. For instance a capacitance of 140 F/g with a voltage window of 2.7 V will yield a specific capacity of 105 mAhg⁻¹ (i.e. 140×2.7/3.6).

It is important to point out that the scientific convention for cycling of electrodes in hybrid battery—supercapacitor Li and Na devices remains similar to that for testing of conventional battery materials, rather than to materials employed for EDLC supercapacitors or for faradaic pseudocapacitors (e.g. surface redox oxides such as Co₃O₄). In literature for hybrid Na and Li electrodes, cycling is often completed as early as after 1,000 cycles, with testing being rarely performed beyond 5,000 cycles. The PSNC-3-800, PSNC-3-850 and PSNC-2-800 electrodes retained 94%, 91% and 92% of the initial capacity after the usual 1000 cycle test span employed for qualifying hybrid system cathodes. PSNC cycling performance is among the state-of-the-art for both Li and Na systems, which is notable since researchers empirically observe Na electrodes cycling worse than Li electrodes. The PSNC cathodes kept working well throughout the 10,000 cycles tested. At the 5,000^{th} cycle, PSNC-3-800, PSNC-3-850 and PSNC-2-800 retained 82%, 84% and 81% of the initial capacity. After 10,000 cycles these values were 73%, 74%, 73%. We attribute the cycling loss to a gradual degradation of the surface oxygen moieties rather than to bulk changes of the carbons' structure. By contrast the CAC electrode retained only 61% of its initial capacity after 5,000 cycles.

We have measured the current density dependence of the capacity in PSNC-3-800 and compared it to various advanced carbon-based materials previously employed as cathodes in both Na and Li hybrid devices. The PSNC-3-800 electrode is quite attractive in comparison to published Na-based systems tested at an identical voltage window. In fact it actually performs on par with some of the best cathodes for hybrid Li devices, which are normally expected to display higher capacities and rate capabilities than Na. The fact that our tested Na adsorption cathode is competitive with Li adsorption cathodes is highly notable since Na is a 39% larger ion that is much more prone to electrolyte solution diffusional limitations while inside the pores of the carbon (a key rate limiting step for ion adsorption electrodes). The Li cathodes are also tested with a wider voltage window (1.5-4.5 V), further giving them a “leg up” over Na in terms of the measured capacity. The Li electrodes considered include mesoporous AC's, functionalized graphene, CNT/graphene composite, and functionalized CNTs.

We also prepared PSNC-3-800 electrode with a mass loading of 2 mg cm⁻² and tested it identically. Although the mass loading is 5 times higher, the capacities were at maximum 17% lower. To estimate the density of an electrode which would operate in a commercial device, we prepared a 15 mg cm⁻² mass loading electrode in a pressed state (100 MPa). The PSNC-3-800 electrode was approximately 240 μm thick, giving a packing density of 0.62 g cm⁻³. This is on par with the 210 μm, 0.71 g cm⁻³ of an identically mass loaded and pressed CAC electrode. We calculated the volumetric capacity of the PSNC-3-800 electrode based on the above density value; this decreases from approximately 100 mAhcm⁻³ at 0.1 Ag⁻¹, to approximately 70 mAhcm⁻³ at 1.6 Ag⁻¹, to approximately 45 mAhcm⁻³ at 25.6 Ag⁻¹.

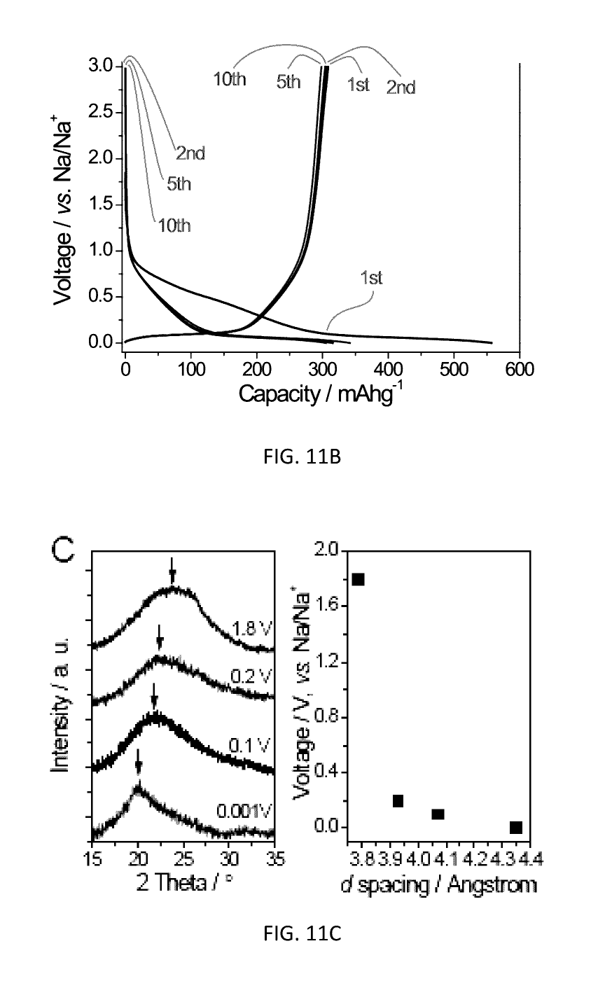

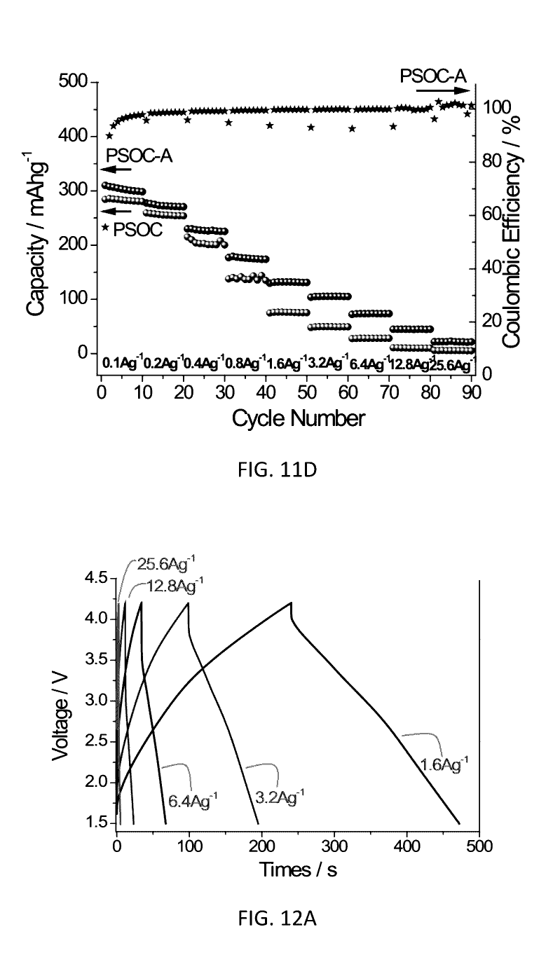

FIGS. 11A-D show the electrochemical performance results for PSOC, which will be employed as the anode in the hybrid device.-PSOC was tested in a half-cell configuration versus Na metal. CV curves of PSOC-A (FIG. 11A) and PSOC half-cells were measured between 0.001 and 3V at a scan rate of 0.1 mVs⁻¹. The CV's display a pair of sharp cathodic (centered at 0.016 V) and anodic peaks (centered at 0.11 V), indicating minimum hysteresis between the charge and the discharge process. Galvanostatic discharge/charge profiles for PSOC and PSOC-A were measured at a current density of 0.1 A g⁻¹ (˜1/3C), for ten cycles (FIG. 11B). As shown in Fig.11B, the galvanostatic curves possess relatively flat charge—discharge profiles, with the majority of the capacity (discharge: 181 of 315 mAhg⁻¹) being accumulated below 0.1 V. The flat charge—discharge plateau and the low voltage are desirable for maximizing both the energy density and the voltage profiles of full devices.

FIG. 11C displays the ex-situ XRD patterns of PSOC electrodes discharged to different cut-off voltages (1.8, 0.2, 0.1 and 0.001 V vs. Na/Na⁺) were measured at a current density of 50 mAg⁻¹. The sodiated carbons were kept in an argon container up to the point of XRD testing. The raw XRD plots along with the calculated mean d-spacing demonstrate sodiation-induced dilation of the intergraphene layers that is synonymous with ion intercalation. This is fundamentally different low voltage charge storage behavior as compared to nanoporous carbons tested against Li metal, where metal plating was indeed experimentally proven to be a key contributor to the total capacity.

We employed air activation to introduce limited additional porosity into the PSOC electrodes. This would both improve the electrolyte access to the bulk of the material and reduced the solid-state diffusion distances due to a lower effective sheet thickness. Through the entire scan rate range of interest (0-20 mVs⁻¹), both the unactivated and the activated electrodes display nearly a square root dependence of the peak current on scan rate. This indicates that the charge storage process for both PSOC and PSOC-A is diffusion-limited, which is expected for intercalation. However, PSOC-A exhibited much improved rate capability (FIG. 11D). At low currents the capacities are not that dissimilar, for example being 315 vs. 290 mAhg⁻¹ at 0.1 Ag⁻¹. At higher currents, such as 3.2 Ag⁻¹ (˜10 C), activation makes a tremendous difference; effectively doubling the capacity from 51 to 107 mAh/g. The rate performance of PSOC-A is among the most favorable in comparison to various carbonaceous materials previously tested as anodes in Na half-cells.

At the 2 mg cm⁻² mass loading the current density dependence of specific capacity of PSOC is only slightly lower relative to the 0.4 mg cm⁻² loading values. Tested within the current density range 0.1 to 25.6 Ag⁻¹, the capacity of the 2 mg cm⁻² electrode is at most lower by 15%. In a pressed state the 15 mg cm⁻² PSOC-A electrode is 100 μm thick with a packing density of 1.5 g cm⁻³, while electrodes identically synthesized from commercial LIB-electrode grade graphite are 80 μm and 1.87 g cm⁻³.

The cycled PSOC-A electrode retained 75% of its original capacity after 10,000 cycles, with coulombic efficiency being at 100% (within the resolution of the instrument) after the first 5 cycles. Such results are highly unusual even for Li anode systems (apart from commercial graphite), since electrode decrepitation and concomitant loss of electrical contact with the current collector inevitably occurs due to repeated volume expansion/contraction associated with charging. However such cycling stability is even more unique for anodes that employ Na as charge carriers due to their larger diameter. The favorable cycling performance of PSOC-A compared to previously published materials may be attributed to its unique “pseudographitic” structure that allows for facile intercalation of large amounts of Na at low voltages. The excellent rate capability results from the very short diffusion distances due the carbons' intrinsic sheet-like morphology further boosted by activation-introduced porosity. The carbons derived from the integral peanut shells exhibit much worse rate performances; for example, the capacity is approximately 260 mAhg⁻¹ at 0.1 Ag⁻¹, compared to the 315 mAhg⁻¹ exhibited by PSOC-A, and approximately 50 mAhg⁻¹ at 3.2 Ag⁻¹, compared to the 107 mAhg⁻¹ of PSOC-A. Materials such as CAC, which are much less ordered and less diffusionally accessible, will likely offer neither the low-voltage flat-capacity plateau nor the rate capability.

We combined the two peanut derived carbons to create hybrid sodium ion capacitors (NICs) with an unparalleled performance for Na class of hybrid devices that actually rivals Li ion capacitors (LICs). For the reasons outlined earlier, one normally does not expect NICs to perform as well as LICs in either rate capability or cycling stability. The rationale for employing PSNC as the cathode and PSOC as the anode is as follows: The PSNC is ideally suited as the cathode since it possesses a relatively large charge storage capability and rate performance in the high voltage region, i.e. 1.5-4.2V vs. Na/Na⁺. When employing the PSOC as the anode we can fully utilize the large plateau capacity in the low voltage region, i.e. near and below 0.1 V vs. Na/Na⁺. We point out that the device would have poor performance if the electrodes were to be swapped. The PSOC anode is a low surface area insertion electrode, with almost all of its capacity being below 0.5 V vs. Na/Na⁺. It would store negligible charge if employed as cathode swinging through a positive voltage range in a device.

Optimizing device performance consists of achieving the widest possible working voltage window without decomposing the electrolyte, while maximizing the capacity of both electrodes. Both of these targets could be realized when the PSOC anode operates within its plateau region while the PSNC cathode swings through the high voltages. In accordance with the principle of balanced charge passing through the cathode and the anode (Q_{cathode}=Q_{anode}), the electrode mass ratio (m_{cathode}/m_{anode}) was kept at 1:1. This is based on a capacity of 161 mAhg⁻¹ for PSNC-3-800 (discharged at 0.1A g⁻¹ to 1.5 V vs. Na/Na⁺) and a 0.1 V vs. Na/Na⁺ plateau capacity of 181 mAh g⁻¹ for PSOC-A at the same rate. The total voltage window for the NIC was 2.7 V. It is important to differentiate the total voltage window for the assembled device presented in FIG. 5, from the voltage windows for the half-cells vs. Na/Na⁺ presented in FIG. 3. The device voltage range was purposely kept at 1.5-4.2 V (rather than at 0-2.7 V) so as to maintain the cathode operating in the ion surface adsorption regime while limiting ion insertion. Since the capacities of the two electrodes are roughly balanced, upon charging of the device the cathode positively swings by ˜2.6 V, while the anode negatively swings by ˜0.1 V (i.e. the flat plateau) to become fully sodiated.

Prior to assembly and testing of the NIC devices, both electrodes were preconditioned in half-cells (i.e. vs. Na/Na⁺). The PSOC anode was firstly galvanostatically (50 mAg⁻¹) cycled three times between 0.001-3 V vs. Na/Na⁺, and then discharged to a cut-off voltage of 0.1 V vs. Na/Na⁺. This left it right above the onset of its high capacity intercalation plateau. The PSNC cathode was discharged (50 mAg⁻¹) to a cut-off voltage of 1.5 V vs. Na/Na⁺, leaving it sodiated to its target capacity. The specific energy and specific power values of assembled NICs were calculated as follows: E=P×t, P=ΔV×i, ΔV=(Vₘₐₓ+Vₘᵢₙ)/2, in this case i being the current normalized by the total active mass in both electrodes, Vₘₐₓ is the voltage at the beginning of discharge after the IR drop and Vₘᵢₙ is the voltage at the end of discharge.

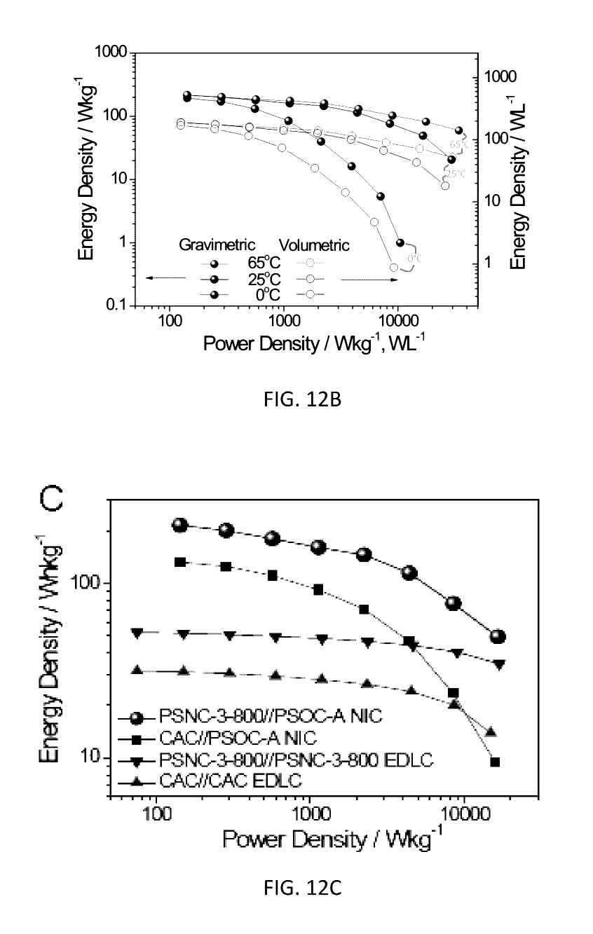

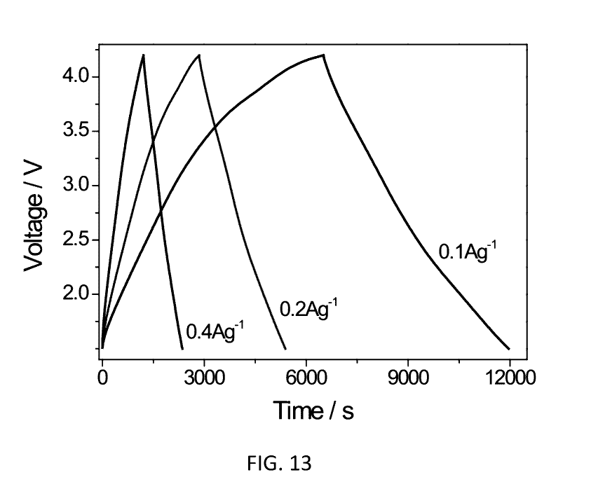

The performance of the NIC device is shown in FIGS. 12A-C. Results in FIGS. 12A-C show devices tested at 1.5-4.2 V. As well, a device was tested in a voltage window of 2.2-3.8 V, which is the identical range specified for an advanced hybrid Li ion capacitor that is commercially available. At a current density of 100 Ag⁻¹, the capacity retention after 100,000 cycles was 98.9%.

FIG. 12A provides the galvanostatic charge and discharge profiles of the hybrid NIC devices at intermediate/high and at low current densities, respectively. The profiles display the desirable symmetric characteristics with low IR drops. At a current density (normalized by mass of anode) of 3.2, 6.4 and 12.8 A g⁻¹, the discharge capacity normalized by that active mass is 83, 57 and 36 mAh g⁻¹. This equals 41.5, 28.5 and 18 mAh g⁻¹ (i.e. 60 Fg⁻¹×2.5V/3.6, 44.3 Fg⁻¹×2.32 V/3.6, and 30 Fg⁻¹×2.15 V/3.6) when normalized by the active mass in the device.

FIG. 12B displays the Ragone plot of PSNC-3-800//PSOC-A NIC at different temperatures, tested at 1.5-4.2V. The gravimetric energy and power density is based on the total active mass in both electrodes. The volumetric energy and power is also plotted, being estimated from a rule of mixtures of the experimentally measured volume of the active cathode and anode. The device worked well at a wide temperature range (i.e. 0-65° C.), yielding very promising energy and power combinations. At 65° C., a superb gravimetric energy density of 60 Wh kg⁻¹ is obtained at a power density as high as 34,000 W kg⁻¹. At the same temperature a volumetric energy density of 52 Wh L⁻¹ is achieved at a power density of 30,000 W L⁻¹. A factor of ⅕ could be used to extrapolate the volumetric performance of a device with realistic mass loading from the performance based on the active materials alone. This conversion qualitatively (different device size, packaging, etc.) places our tested button cells in the range of commercial LIC devices.

FIG. 12C displays the Ragone plot of PSNC-3-800//PSOC-A NIC at room temperature, with the specific energy/power density being based on the total mass of the active materials. The figure also shows a NIC based on CAC//PSOC-A, as well as symmetric EDLC devices based on CAC//CAC and PSNC-3-800//PSNC-3-800. Here the voltage window was 1.5-4.2 V, except for the symmetric EDLC devices which were tested within a voltage of 0-3V, i.e. actually a wider window than for the hybrids. However the EDLC systems are markedly inferior to the PSNC-3-800//PSOC-A configuration. In fact, the PSNC-3-800//PSOC-A system is superior at both low and high power, sacrificing nothing to the EDLC configurations, which are supposed to be superior at high rates. This is a direct testament of the exquisite high-rate intercalation kinetics of the PSOC anode, since solid-state diffusion is normally considered the rate-limiting step for Na battery electrodes. Even at the very power of 16,500 Wkg⁻¹ the PSNC-3-800//PSOC-A device delivers a respectable 50 Whkg⁻¹ of energy.

It is instructive to compare the energy—power characteristics of our tested device to examples of the state-of-the-art reported in literature. A key distinction between NICs/LICs versus asymmetric aqueous electrolyte based supercapacitors (often also termed “hybrids”), is that for the latter electrical charge is primarily stored by a combination of EDLC and surface pseudocapacitance. Unlike for NICs and LICs, there is negligible ion insertion into the bulk of the anode. While pure EDLC systems may cycle for up to 1,000,000 cycles (albeit at a lower energy), optimized asymmetric aqueous electrolyte based supercapacitors typically last 10,000 cycles and may fail by dissolution and/or coarsening of the oxide.

The Li/Na ion capacitors listed include various systems coupling a battery anode and a capacitor cathode, such as, AC//graphite (Li⁺), AC//hard carbon (Li⁺), AC//Li₄Ti₅O₁₂ (Li⁺), AC//TiO₂-RGO (Li⁺), 3D-porous graphene-sucrose//Li₄Ti₅O₁₂/G (Li⁺), ACH3D-TiO₂/CNT (Li⁺), 3D-Graphene//Fe₃O₄-graphene (Li⁺), AC//V₂O₅-CNT (Na⁺), AC//NaₓH₂₋ₓTi₃O₇ (Na⁺), AC//NiCo₂O₄ (Na⁺), AC//AC/MnO (Li⁺). The supercapacitors mentioned include asymmetric aqueous systems like activated-graphene//MnO₂/activated-graphene, Ni(OH)₂-graphene//porous graphene, graphene//2D-MnO₂, and symmetric liquid ion systems. As may be seen form this master comparison plot, the system developed in the current study is overall quite promising.

The cycling stability of the PSNC-3-800//PSOC-A NIC was firstly investigated at a current density of 6.4 Ag⁻¹. Using a maximum voltage of 4.2 V the device will retain 79% of its initial capacity after 1,000 cycles, 69% after 5,000 cycles, and 66% after 10,000 cycles. When we employed a smaller cut-off voltage of 3.5 V, the capacity retention increases to 81% at cycle 5,000 and 72% at cycle 10,000. We hypothesize that this improvement corresponds to reduced rates of degradation in the PSNC oxygen functionalities at the lower potential window. At both voltage windows the hybrid capacitors displayed excellent coulombic efficiencies, being near 100% during cycling. As a comparison, NIC device reported in previous in literature displayed 27, 22 or 37% capacity decay after a limited number of cycles (˜1,000, or 2,000) at lower voltage region (below 3V). Our cyclability in our tested embodiment is actually comparable to the previously published LIC devices. For reasons ascribed to the higher levels of volume expansion for a comparable capacity associated with Na vs. Li insertion, achieving an on par cyclability with a NIC is indeed a notable feat.

Finally, we also followed the cycling test parameters similar to those employed by a commercial LIC device manufacturer (Ultimo™), which are listed on their website. The devices were tested for 100,000 cycles between 1.5-3.5 V (51.2 Ag⁻¹), both at 25° C. and at 65° C. Our tested NICs achieved energy/power densities of 8-20 Wh kg⁻¹ at ˜50000 Wkg⁻¹ (active material normalized), retaining 88% and 78% of their capacity after 100,000 cycles at 25 and 65° C. As mentioned earlier, we tested the cycling stability of PSNC-3-800//PSOC-A NIC at a current density of 100 Ag⁻¹ and a voltage window of 2.2-3.8V, which are the current density and voltage window quoted in ref. 96. After 100,000 cycles our tested NIC's capacity degraded by only 1.2%. These values are fully competitive with Ultimo LICs according to the information provided on the manufacturer website. Once again this highlights the attractiveness of our approach considering that in an embodiment our electrode materials are fabricated from waste peanut shells and hence to use the expression “cost peanuts”, run on Na rather than on Li, and should be further improvable with industrial-style engineering optimization (electrode fabrication process, electrolyte component adjustment, etc.).

### Experimental Section—Materials

In our studies, we employed shells from the peanuts grown and roasted in the Shandong region of China, bags of which the author (HW) gave to the research group as a going away gift. The obtained biomass was firstly soaked in ethanol for 2 weeks, and then washed with MQ-water (Ultrapure water with 18.2 MΩ·cm at 25° C. obtained in Milli-Q water purifier system, Millipore Corporation) and thoroughly dried before use. Rough grinding was used to separate the inner from the outer peanut shell. The PSNC cathode materials were synthesized as follows: A ratio of 1.5 g of outer shell, 2.5 mL of concentrated sulfuric acid and 50 mL of MQ-water were sealed in a 100 mL stainless steel autoclave. The autoclave was heated at 180° C. for 48 h and then cooled down naturally. The resulting biochar was collected by filtration, washed with MQ-water and then dried. The yield of biochar is approximately 0.8 g. The dried biochar and activation agent (KOH), in a mass ratio of 1:2 or 1:3, were thoroughly ground and mixed using an agate mortar and pestle. Activation was carried out in a tubular furnace at 800 or 850° C. for 1 h under argon flow. The activated samples were thoroughly washed with 2M HCl and MQ-water, and finally dried in an oven at 100° C. overnight. The final yield of the PSNC carbons was in the 19-29% range (based on the weight of the biochar). The PSOC anode materials were synthesized as follows: A mass of 2 g of the inner shell carbonized in argon at 1200° C. for 6 h. This resulted in a yield of approximately 0.7 g, i.e. 35%. To remove impurities the obtained carbon was thoroughly washed using 20% KOH at 70° C. for 2 h, and 2M HCl at 60° C. for 15 h, followed by MQ-water. Activation for the PSOC-A was performed at 300° C. for 9 h with dry air flown at 50 sccm min⁻¹. The activated carbons were then washed again using the above procedure.

Material Characterization

The surface area and porous texture of carbon materials are characterized by nitrogen adsorption at 77 K (Quantachrome Autosorb⁻¹). Prior to the gas sorption measurements, the samples were outgassed at 250° C. for 4 h under a vacuum. The pore size distribution (PSD) being calculated using density functional theory (DFT) model from the adsorption branch. The pore size distributions were evaluated by a nonlocal DFT method using nitrogen adsorption data and assuming slit-pore geometry. To characterize the morphology of the carbon samples, field emission scanning electron microscopy (FE-SEM) (Hitachi S-4800) and transmission electron microscopy (TEM) (JEOL 2200FS, 200 kV) are used. Low loss electron energy loss spectroscopy (EELS) was performed with scanning TEM (STEM) mode with a nominal electron beam size of 0.5 nm. The carbon compact's electrical conductivity was measured using Pro4 from Lucas Laboratories. X-ray photoelectron spectroscopy (XPS) measurements are performed on an ULTRA (Kratos Analytical) spectrometer using monochromatic Al—K_{α} radiation (hυ=1486.6 eV) run at 210 W. Before XPS analysis, the samples were dried at 110° C. in vacuum oven overnight to remove the absorbed water. X-ray diffraction (XRD) analysis was performed using a Bruker AXS D8 Discover diffractometer with the Cu K radiation. The Raman spectra were recorded with a confocal microprobe Raman system (Thermo Nicolet Almega XR Raman Microscope).

Electrochemical Testing

All the electrodes were prepared by coating electrodes slurries (75 wt % active material, 15 wt % carbon black, and 10 wt % polyvinylidenediflouride dissolved in N-methylpyrrolidone) on stainless steel spacers, and then dried at 120° C. under vacuum overnight. The typical mass loading of the electrodes was 0.4 mg cm⁻² and each electrode has area of 1.77 cm². To ensure that this mass loading was adequate for representing the electrochemical performance of a higher loaded electrode, additional testing was performed on both the cathodes and the anodes loaded with 2 mg cm⁻². Commercial mass loading electrodes (15 mg cm⁻²) were prepared identically but pressed at 100 MPa in the final step. Half cells were constructed using standard 2032 button cells, with Na metal as the counter electrode, a polyethylene-based separator, and 1M NaClO₄ in 1:1 (volume ratio) ethylene carbonate (EC): die1thyl carbonate (DEC) as the electrolyte. Button cell-based Na-ion capacitor (NIC) devices were constructed using opposing carbon electrodes with the same separator and electrolyte. All the cell fabrication and disassembly was performed inside an Ar filled glove box with sub-0.1 ppm water and oxygen contents. To confirm that passivation of Na metal was avoided we cycled Na—Na cells. We found that there is no degradation of Na—Na cell during the tested 5,000 cycles. Galvanostatic charge/discharge profiles were performed using the BT2000 Arbin electrochemical workstation. Cycling voltammetry and electrochemical impedance spectroscopy (EIS) measurements performed using a Solartron 1470 Multistat system.

Separation of inner shells and outer shells may also be accomplished by other mechanical methods such as employed for separating fiber from hurd in bast plants and chemical separation methods such as preferred dissolution, freezing and fracture and preferred oxidation of the less stable species.

In the particular separation process disclosed, soaking may be accomplished using other chemicals such as methanol, isopropyl and acetone. Soaking favors easy separation by causing the shells to swell. More aggressive mechanical separation may be effective without a prior alcohol soak. Washing is not essential for the success of the synthesis process, particularly since the final hydrothermal product is washed as well. High purity water is not required. For grinding, drying is optional. Wet grinding is possible.

In the hydrotreatment of the outer shell, the molarity of acid (in water) may be varied and different varieties of acid may be employed, for instance sulfuric, nitric, hydrochloric, acetic, perchloric, anything to change the pH. In a different embodiment, hydrothermal may be done in an alkaline environment, so KOH may be used to change the pH to more basic. Water is required for both processes though.

Hydrothermal treatment can work at high pressure using supercritical water, so T can easily go above 100° C. i.e. boiling of water at 1 atm. There really is no theoretical upper bound except the corrosion/rupture stability of the reactor, e.g. 1000° C. The lower bound is probably just ambient, say 25° C., since at lower temperature it just won't work fast enough. At lower temperature more extreme pH and potentially longer times would be required.

Activation may be done from the melting point of the activating agent, for example 406° C. for KOH, upwards to the stability of the furnace. A practical upper limit is 1750° C., beyond which most finances no longer function. NaOH may be used instead of KOH.

The final product may need to be separated from the activation agent and dried before use. Water is the standard medium used for cleaning off a KOH as the activating agent but drying can be done at higher T or at ambient, depending on the time allowed and the final application. If the end use is an aqueous environment, e.g. a supercapacitor running on KOH, drying does not need to be complete.

For the treatment of the inner shell, heat treatment is from 400-1750° C. Below roughly 400° C. carbonization does not occur. Cleaning is flexible. Water is the cheapest and any cheap acid may be used for removing residual inorganic impurities. If removing inorganics is not essential (it is not in many applications), no acid is needed and the specimen may not need washing. Activation temperature can be tuned to the desired pore content and may be as low as 200° C. and as high as 1750° C. For instance carbonization and activation may be both done at 1500° C. All what would be needed is for the atmosphere to be switched from inert (carbonization) to aggressive such as air or CO2 (activation).

The thermal treatment, activation and cleaning processes also apply to other shells with adjusted parameters depending on the actual materials used.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. An electrical energy storage device having an anode and cathode, at least one of the anode and cathode comprising separated inner shells or outer shells of a legume or nut that have been treated to obtain treated inner shells or outer shells with a macroscopically open structure composed of graphene or of carbon nanosheets.

2. The energy storage device of claim 1 in which:
the separated inner shells or outer shells are inner shells primarily composed of lignin;
the treated inner or outer shells comprise the inner shells that have been treated to form a structure composed of inter-dilated graphene layers for intercalating ions; and
the treated inner shells comprise the anode.

3. The energy storage device of claim 2 in which:
the separated inner shells or outer shells are outer shells comprising multi-phase tissue including a cellulosic fibril network;
the treated inner shells or outer shells comprise the outer shells that have been treated to form a structure composed of interconnected carbon nanosheets that provide adsorption sites for ions;
the treated outer shells comprise the cathode.

4. The energy storage device of claim 1 in which the treated inner shells or outer shells are thermally treated outer shells that form the cathode and have a structure created by pyrolysis in the presence of water.

5. The energy storage device of claim 1 in which the inner shells or outer shells are inner shells or outer shells of a peanut.

6. The energy storage device of claim 1 formed as a hybrid ion capacitor.

7. An electrode suitable for forming an anode or a cathode of an energy storage device, the electrode, if an anode, comprising inner shells of a legume or nut formed primarily of lignin that have been thermally treated, the thermally treated inner shells being formed of pseudo-graphitic arrays of carbon, carbon of the thermally treated inner shells being activated to form inter-dilated graphene layers for intercalating ions, and, if a cathode, comprising outer shells of a legume or nut that have been treated, the treated outer shells being formed of interconnected carbon nanosheets, the outer shells including a cellulosic fibril network, and the treated outer shells being formed of interconnected carbon nanosheets that provide adsorption sites for ions.

8. The electrode of claim 7 in which the electrode is an anode.

9. The electrode of claim 7 in which the electrode is a cathode.

10. The electrode of claim 7 in which the inner shells and the outer shells are respectively inner shells and outer shells of peanuts.

11. A method comprising separating shells of a legume or nut into inner shells having a macroscopic sheet-like structure and outer shells, and treating the inner shells or the outer shells to obtain a macroscopically open structure composed of graphene or of carbon nanosheets.

12. The method of claim 11 in which treating the inner shells or the outer shells comprises treating the inner shells by carbonizing the inner shells to produce carbonized inner shells.

13. The method of claim 12 further comprising washing the carbonized inner shells with water.

14. The method of claim 12 further comprising washing the carbonized inner shells with an aqueous solution of an acid.

15. The method of claim 12 further comprising washing the carbonized inner shells with an aqueous solution of a base.

16. The method of claim 12 in which carbonization is carried out at 400-1750° C.

17. The method of claim 12 further comprising activating the carbonized inner shells without destroying the macroscopic sheet-like architecture characteristic of untreated inner shells to produce activated carbonized inner shells.

18. The method of claim 17 in which activating is carried out at 200-1750° C.

19. The method of claim 17 further comprising washing the activated carbonized inner shells with water.

20. The method of claim 17 further comprising washing the activated carbonized inner shells with an aqueous solution of an acid.

21. The method of claim 17 further comprising washing the activated carbonized inner shells with an aqueous solution of a base.

22. The method of claim 17 further comprising assembling anodes including activated carbonized inner shells for use in an electrical energy storage device.

23. The method of claim 11 in which treating the inner shells or the outer shells comprises treating the outer shells until one or several phases comprising the outer shells are preferentially etched, producing preferentially etched outer shells, followed by washing and drying the preferentially etched outer shells.

24. The method of claim 23 in which preferential etching is carried out in the presence of water and a pH-changing agent with or without heat.

25. The method of claim 23 further comprising activating the preferentially etched outer shells, producing activated preferentially etched outer shells.

26. The method of claim 25 in which activating the preferentially etched outer shells is carried out using an activation agent having a melting point and the activating is carried out above the melting point.

27. The method of claim 25 further comprising separating the activated preferentially etched outer shells from the activation agent.

28. The method of claim 27 in which separating the activated preferentially etched outer shells from the activation agent is carried out by washing the activated preferentially etched outer shells with water.

29. The method of claim 25 further comprising drying the activated preferentially etched outer shells.

30. The method of claim 25 further comprising assembling cathodes including activated preferentially etched outer shells for use in an electrical energy storage device.
